(19) United States
(12) Patent Application Publication
(10) Pub. No.: US 2006/0286929 A1
(43) Pub. Date: Dec. 21, 2006

(54) System for universal distribution of short duration programming

(75) Inventors: Hubert J. Schlafly, Greenwich, CT (US); Thomas L. Gallagher, Greenwich, CT (US)

Correspondence Address: ST. ONGE STEWARD JOHNSTON & REENS, LLC, 986 BEDFORD STREET, STAMFORD, CT, 06905-5619, US

(73) Assignee: WUTP, Inc.

(21) Appl. No.: 11/388,561

(22) Filed: Mar. 24, 2006

Related U.S. Application Data
(63) Continuation-in-part of application No. 11/157,501, filed on Jun. 21, 2005.

(51) Int. Cl. H04H 7/00

(52) U.S. Cl. 455/3.06

(57) ABSTRACT

A system for transmission of a relatively short-duration program to a receiving device, the program transmitted to the receiving device and stored in memory such that the program may be presented to the user based upon a schedule selected by the user. The program content may be tailored to the user based upon pre-selected settings selected by the user.

### CROSS REFERENCE TO RELATED APPLICATIONS

This application is a continuation-in-part of pending U.S. Application Ser. No. 11/157,501 filed Jun. 21, 2005.

### FIELD OF THE INVENTION

The invention relates to a system and method for transmitting a universal short duration program to a listener, and more specifically to a system and method for providing a transmitted signal containing program content to be received by a plurality of authorized recipients via a receiver based on mobile telephone technology.

### BACKGROUND OF THE INVENTION

Most if not all homes have multimedia devices capable of receiving some sort of transmitted programming including for example, television, radio (local and/or satellite), personal computers and so forth. Time settings and alarm features on many of these devices have also become widely used, including for example, time setting features that turn on or activate a device or features that gradually ramp up in volume of audio signals at a selected time.

However, the listener is typically limited in the types of programs that may be received by the particular device. For example, with television and radio systems, the listener must select a program from those broadcast by the various channels and stations. While, stations have sought to increase the types and quantity of programming for a user to select from, this is not true in all areas of the country, and certain types of programming are typically not broadcast. Relatively short duration programming directed to, for example, religious content such as a prayer or service is typically not broadcast. The difficulty is that a listener must tune into the station at the correct time to hear the prayer or service. However, if the time is missed, the listener has missed the program. Repetitive programming (e.g. playing of short program content over and over) could be employed, however, this type of programming is typically not broadcast on television or radio stations due to the limited broadcast channels and availability of time segments. In addition, use of the television systems requires the user to obtain a television, which are relatively large, and may further require, a cable box and cable installation, or a satellite dish and installation hardware. These are relatively large and expensive systems, especially if the system is only to be used to receive a relatively short duration program. In these examples, the system includes a relatively large amount of equipment and functionality that is not required.

Still further, radio may be used, however, with a radio system, a radio transmitter and receiver are required, which must comply with FCC standards and regulations. In addition, radio transmission is necessarily limited in geographic area by the limit of the transmitting tower. Therefore, to reach individuals in differing geographic areas, many different radio stations must broadcast the program.

On the other hand, a large variety of programming may be accessed via, for example, the Internet. However, to access this information typically requires a computer with a network connection. In addition, it is difficult to set the computer to receive a particular program and present that received program to a listener at a particular time. Any adaptation of a computer system to provide this functionality would be expensive, bulky and very complicated. In addition, a large amount of functionality is provided that is unnecessary for the application.

Another drawback to using a computer to receive specialized programming is that, one must be physically located at the computer connection to access the program content. While wireless Internet connections are known, these require the user to have a computer, a wireless transmitter and the computer to be equipped with a wireless card, all of which can be very expensive. Additionally, while portable computers are continually being reduced in size, they are still relatively large in size relative to, for example, a compact mobile phone sized device.

What is desired then is a system and method that provides for an increased variety of specialized programming that is presented to a user in a cost effective manner.

It is further desired to provide a system and method that provides for an increased variety in programming that is presented to a user, which may be accessed and received by the user from various geographic locations with a portable receiving device.

It is still further desired to provide a system and method that provides for an increased variety in programming that is presented to a user and includes a storage feature for later playback, and an alarm feature to present the program to the user at a selected time.

It is yet further desired to provide a system and method that provides for a relatively short program that is presented to the user at a time selected by the user.

It is still further desired to provide a system and method that provides for a relatively inexpensive universal broadcast to a large number of users.

### SUMMARY OF THE INVENTION

These and other objectives are achieved in one advantageous embodiment, by the provision of a portable receiving device that utilizes mobile cellular telephone technology, for receiving an input signal containing relatively short duration program content to be presented to a user.

It is contemplated that an incoming signal comprises program content transmitted via a mobile telephone network. The program content may be received at any location that the mobile device has service, for example, within range of a cellular transmitting tower.

In this manner, the user is provided with an extremely versatile system. The user is not limited to a particular location in the house, such as would be the case with television and computer connection. The mobile device may comprise a relatively small, inexpensive device with mobile telephone type technology that could be placed, for example, on a night stand next to the user's bed, in the user's car, on the user's desk at work, or in a hotel room when traveling, etc. In any event, the user is provided with a fully portable device that may receive program content whenever in service range.

The program may comprise relatively short duration program content. Such relatively short duration programming does not lend itself to television and/or radio station broadcast due to the limited scope of the program content. However, this type of specialized broadcast programming may effectively be transmitted via a signal sent to a mobile phone type device. Such broadcast programming may comprise for example, a religious program including prayer/dedication, music, or combinations thereof such as when the alarm is set in the morning or any time of day to gently wake the user from sleep which might be presented to the listener as a gradually increasing volume signal. The user may choose to repeat the message at another time during the day.

The receiving device may, in one advantageous embodiment, be provided with a telephone number or identifier that the system has associated with a particular program to be broadcast, such as a particular language or religious affiliation. The receiving device may further include a memory to store the program until the user is ready to listen. For example, the program content could be universally broadcast to the receiving device at a relatively early hour in the morning, e.g. 1 am, which is stored in the memory, and then presented to the user at, for example, 7 am, which time corresponds to the wake-up alarm setting selected by the user. It is contemplated that the program content may be presented to the user at any time or even multiple times during the day as desired. If the receiving device is not connected to the telephone network at the preplanned transmission time (is turned OFF), the program presently stored in memory is available for play back at the set alarm time or other time selected by the user. Alternatively, the programmed may be queued for transmission when the receiving device does connect to the telephone network.

In this manner, the program content need only be sent once, since it is stored in the receiving device memory for later access. The program may last for a specific time interval such as, for example but not limited to, five minutes. When presented to the user, the program may e scheduled to repeat until automatically turned OFF or until manually turned OFF by the user. Although the program content may normally change on a daily basis, the same message may be accessed at any time during the day prior to transmission of new program content the following day. It is contemplated that upon transmission of new program content, the existing content from the day before may automatically be overwritten. In this manner, the memory may be kept to a minimum thereby minimizing the cost of the receiving device. It is further contemplated that multiple programs may be transmitted to the receiving device on a daily basis to be presented to the user according to a schedule. For example, it may be used as a call to prayer several times a day.

In one advantageous embodiment a system for transmission of a program to a receiving device is provided comprising a receiving device identifier, such as a unique telephone number, to identify a connected receiving device and a program to be transmitted to the receiving device. The system further comprises a transmitter for transmitting the program to the receiving device, a storage located in the receiving device for storing the program, and a schedule set by the user for presentation of the program to the user. The system is provided for presenting the program to the user according to the schedule or at a different time chosen by the user.

In another advantageous embodiment a system for transmission of a program to a user is provided comprising a program distributor/transmitter and, a program transmitter/receiver at the receiving device responsive to an identification signal from a connected portable device, and an identifier for identifying the connected portable device. The program transmitter/receiver is provided such that a program signal is transmitted to the portable device. The system is further provided such that the mobile device includes a device controller for controlling the presentation of the program, and a portable device transmitter/receiver for transmitting the identification signal to the program distributor/transmitter and for receiving the program signal. The portable device may further comprise a signal analyzer coupled to the portable transmitter/receiver for analyzing the received program signal, a memory for storing the received program signal upon determination that the received program signal comprises a valid program, and a schedule for presentation of the program to the user. The system is provided such that the portable device presents the program to the user according to the schedule.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 2 is a block diagram according to FIG. 1 illustrating the program content distributor/transmitter in greater detail.

FIG. 3 is a block diagram according to FIG. 1 illustrating the portable device in greater detail.

FIG. 4 is a block diagram according to FIG. 3 illustrating the portable device in greater detail.

### DETAILED DESCRIPTION OF THE DRAWINGS

Referring now to the drawings, wherein like reference numerals designate corresponding structure throughout the views.

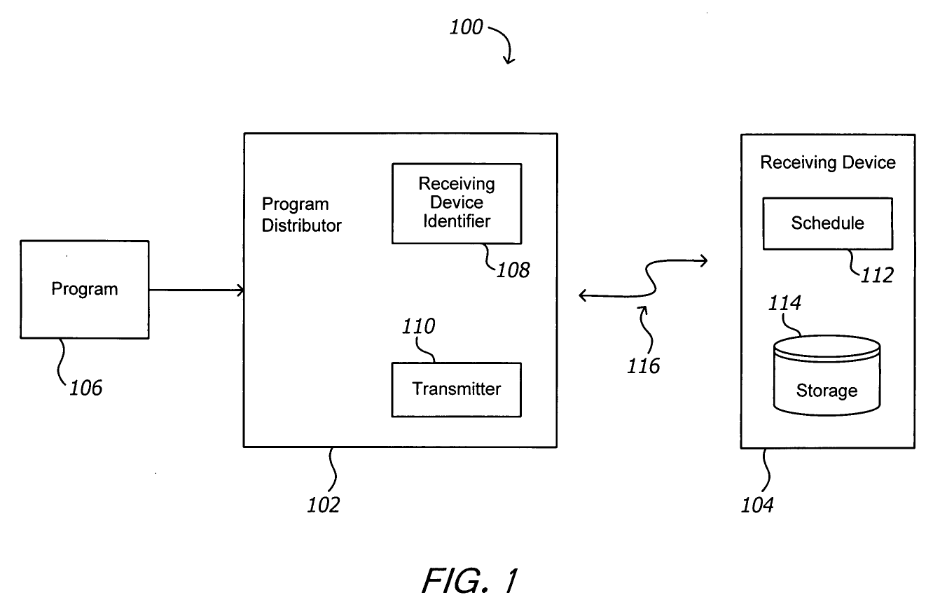

FIG. 1 depicts a system 100 for transmission of a program to a user. The system 100 generally comprises a program distributor/transmitter 102 and at least one portable device 104.

The program distributor/transmitter 102 receives a program 106, which is in turn transmitted to the portable device 104 for presentation to the user. Program 106 may comprise any type of program material, but in one advantageous embodiment comprises audio content. For example, it is contemplated that program 106 comprises a religious message including for example, a dedication of ones first thoughts of the day to moral and spiritual values, which may also include music. This message may be provided to the listener as a gently increasing volume of a discrete program having a predetermined length. In one advantageous embodiment, the program may comprise distant ringing church bells that increase in volume to, for example, gently wake the listener from sleep. As the program continues, full volume may be reached.

Program distributor/transmitter 102 may comprise in one advantageous embodiment portable device identifier 108 and transmitter 110. In this manner, once portable device 104 is turned on and couples with program distributor/transmitter 102 via a wireless connection 116, which may comprise a portable telephone connection, mobile device identifier 108 identifies mobile device 104 and sends program 106 to portable device 104 via transmitter 110.

Portable device 104 may comprise in one advantageous embodiment, schedule 112 and storage 114. Once portable device 104 receives program 106, it may be stored in storage 114 for later retrieval. Schedule 112 may be an alarm setting selected by the user for the time of audio and/or visual presentation of program 106. For example, in one advantageous embodiment, program 106 may be transmitted during the early morning hours (e.g. 3 am) to portable device 104 to be stored in storage 114. At a selected time (e.g. 7 am) schedule 112 prompts portable device 104 to present program 106 to the user, which may for instance, correspond to a wake-up time. Alternatively, the user may select any time during the day for hearing the program or may select multiple times during the day to listen to the program as desired.

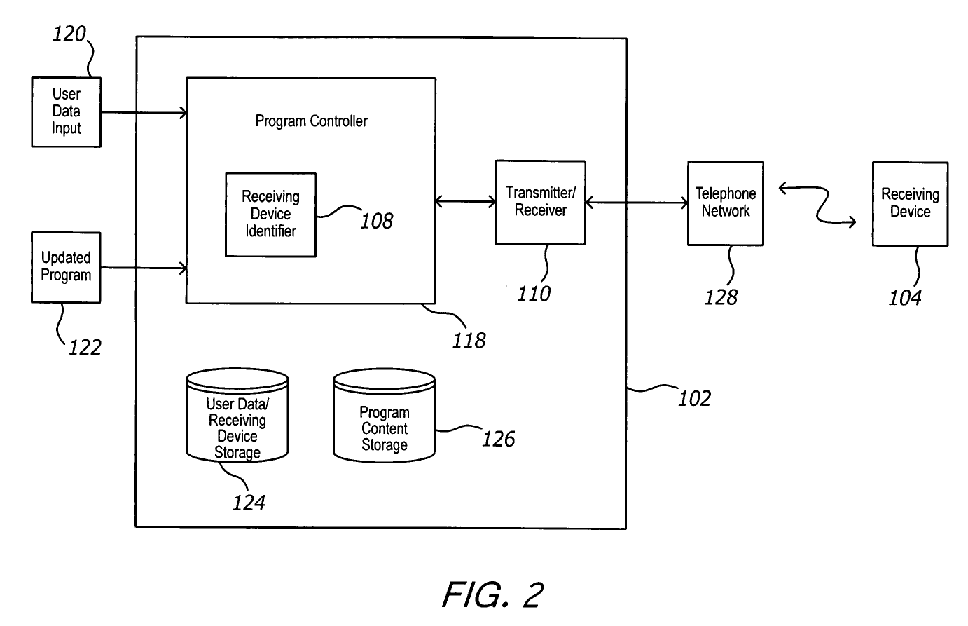

Turning now to FIG. 2, program distributor/transmitter 102 is illustrated in greater detail. Program distributor/transmitter 102 includes program controller 118, which receives user data input 120 and updated program 122.

User data input 120 may comprise data associated with a particular user and portable device 104. For example, a user may sign up to receive service from system 100 and in one advantageous embodiment, purchases portable device 104. Portable device 104, may in one advantageous embodiment, have an associated phone number and identification, which can be supplied to program controller 118 as part of user data input 120. In one embodiment, the portable device 104 is programmed to receive one of a number of various types of program content he/she wishes to receive. For example, when program 106 comprises religious content, the user may indicate his/her denomination and language in which they wish to receive program 106.

In one advantageous embodiment, it is contemplated that depending upon the user's particular selection of program content, portable device 106 may be programmed with a phone number to receive that selected program 106. For example, portable device 106 may be provided such that no voice transmission from portable device 106 is possible, rather only audio reception is possible. In this manner, all portable devices 106 associated with particular program content may be assigned the same phone number. Alternatively, each portable device 106 may be provided with a separate phone number and/or identifier, which may then be associated with selected program broadcast content.

User data input 120, once input to program distributor/transmitter 102, may then be stored in user data/portable device storage 124 for later retrieval.

Also shown in FIG. 2 is updated program 122, which may comprise a daily program to be presented to the user. Updated program 122 may be stored in program content storage 126, which stored updated program 122 for later retrieval. It is contemplated that quite a number of varied updated programs 122 may be used. For example, when program 106 comprises religious content, updated program 122 may comprise one of many differing prayers directed toward a particular religious denomination. In addition, each denomination may be provided in various languages depending upon the user's preference.

Once updated program 122 is stored in storage 126, at a selected time, program controller may retrieve program 106 and send it to an identified portable device 104 via transmitter/receiver 110 over a telephone type broadcast network 128. Transmitter/receiver 110 is provided to receive a signal from portable device 104 through which portable device identifier 108 can identify portable device 104. In this manner, once identified, program controller 118 can select the correct program content for transmission based upon the stored user data 120 in user data/portable device storage 124.

Transmitter/receiver 110 may comprise virtually any industry standard transmitting and receiving device capable of coupling to a commercial telephone network 128 for transmission of data over the telephone network.

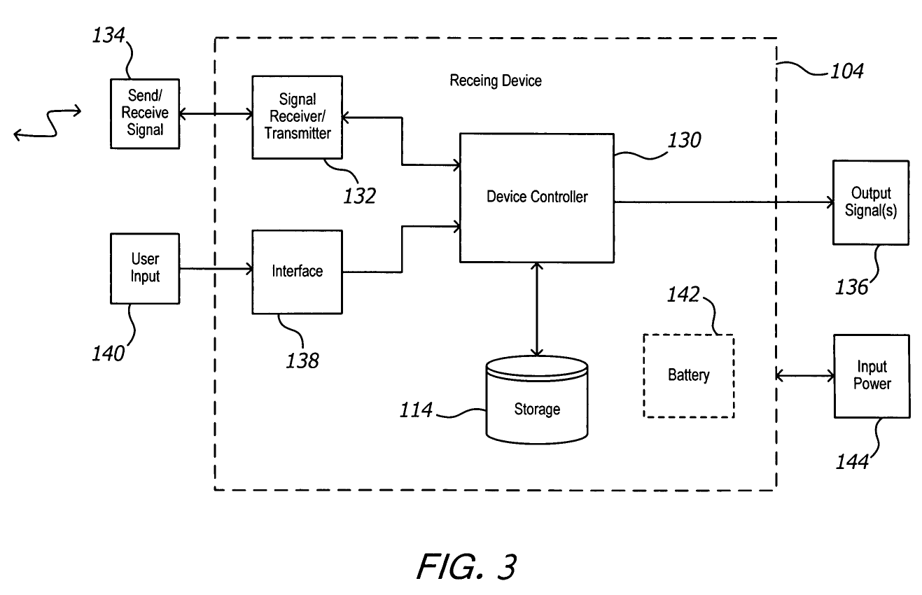

Referring now to FIG. 3, portable device 104 is illustrated in greater detail. For example, portable device 104 includes device controller 130, which is coupled to signal receiver/transmitter 132 for sending a signal 134 to program distributor/transmitter 102 to identify portable device 104. Receiver/transmitter 132 is further provided to receive transmitted program 106 as signal 134 to be processed by device controller 130 and stored in storage 114 for later retrieval. Device controller 130 may then access program 106 and present it to the user as output signal(s) 136.

Portable device 104 is further provided with interface 138, which may comprise a number of buttons for programming portable device 104. For example, interface 138 may comprise an alarm set button to set a wake up time and allows the user as a user input 140 to set that time using fast/slow buttons to sequence the time through a 24 hour period as is common on standard alarm clocks. After setting the alarm feature, the user can review or change the schedule or alarm time by again pressing the set button.

Also shown in FIG. 3 is battery 142 and input power 144. Battery 142 may comprise in one advantageous embodiment, a rechargeable battery, such as but not limited to, Lithium Ion (Li-Ion) batteries as are commonly used with cellular telephones, or NiMH rechargeable batteries. It is further contemplated that battery 142 may comprise one or more batteries. Input power 144 may comprise standard wall power 120-240 VAC ±15% 50-60 Hz which may be plugged directly into portable device 104. Alternatively, input power 144 may include a charging station to which portable device 104 is coupled. The charging station may include a converter to convert the AC power to a particular voltage level for charging of battery 142. Therefore, portable device 104 may utilize battery power in conjunction with a charging station, or may be provided with a direct cord and plug attachment for connecting into an electrical outlet.

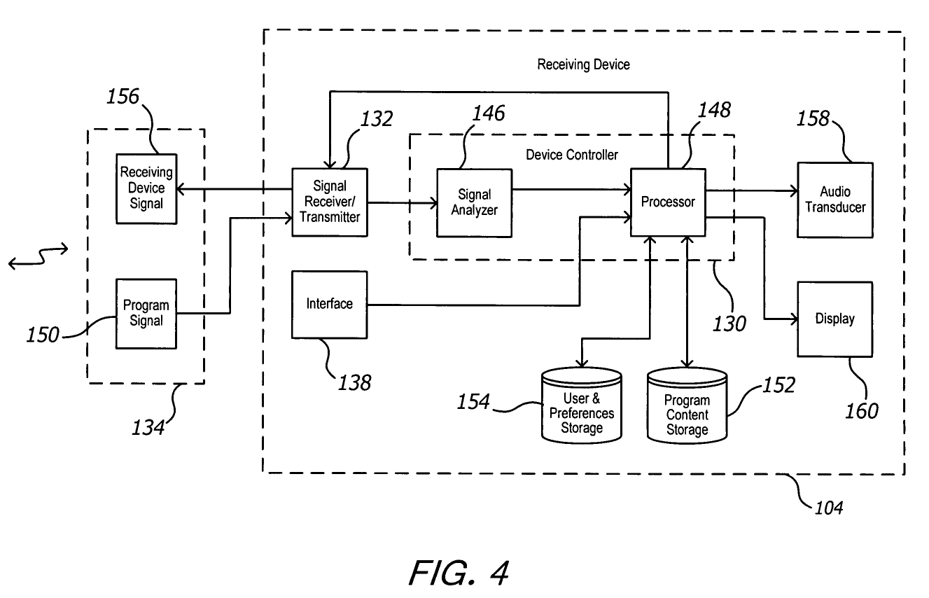

Turning now to FIG. 4, another embodiment of portable device 104 is illustrated. Device controller 130 is shown comprising, for example, signal analyzer 146 and processor 148. Processor 148 is coupled to signal receiver/transmitter 132 for transmitting portable device signal 156 to program distributor/transmitter 102 for identification of portable device 104.

Signal analyzer 146 is also coupled to signal receiver/transmitter 132. Signal analyzer 146 receives program signal 150 and analyzes it to determine if it is a valid signal. If signal analyzer 146 determines that program signal 146 is a valid signal, program signal 150 is input to processor 148, which in turn stores it in program content storage 152 for later retrieval. If signal analyzer 146 determines that program signal 150 is not a valid signal, the signal is discarded. For example, as portable device 104 is provided with a phone number and is connected to the commercial telephone network 128, it is contemplated that another individual could accidentally call portable device 104. However, it is important not to corrupt program 106 when receiving an invalid call. Therefore, analyzer 146 can analyze the incoming content to determine if the signal is valid or not.

Also illustrated in FIG. 4 is user and preferences storage 154, which may be used to store any inputs from interface 138.

Audio transducer 158 and display 160 are still further illustrated in FIG. 4. When portable device 104 comprises a standard cellular telephone, display 160 may comprise any standard display common to cell phones. Alternatively, when portable device 104 is provided as a dedicated receive only device as previously discussed above, display 160 may a relatively simple display comprising, for example, eight in-line LCDs for displaying the local time of day transmitted, for example, by the cell phone service provider in the HH:MM and AM or PM format. In this manner, display of the time assures the user that portable device 104 is on and ready to perform.

When the set time matches the time of day the program 106 is transmitted to audio transducer 158. A volume control may further be provided in interface 138 to adjust the sound level. The message and pause time (the interval between replays) stored in program content storage 152 may be repeated for a selected number of times (e.g. stored in user and preferences storage 154) before an automatic off activates or the user presses an off button. Even if the phone is turned off, the set time and the program 106 may remain in program content storage 152, unless changed, and be available when the unit is again turned on.

It is contemplated that in one advantageous embodiment, portable device 104 may be packaged in a form suitable for a bedside table, complete with a rechargeable battery and an external charger that can be connected to a house outlet. Thus the portable unit 104 may be moved from room to room or to an external (hotel room) site, for use anywhere cell phone service is available.

While the system 100 has been discussed in connection with receiving a program 106 that comprises religious content, it is further contemplated that virtually any type of program content could be transmitted to portable device 104. For example, a warning or emergency message might be sent at any time of day. The user can review any message, stored in memory, by pressing a play button. Additionally, local, national and/or international news may be provided to the user. Specific financial reports could be presented. Sports reports may also be presented. These are simply a few of the many types of information that may be presented to the user for their use. It is further contemplated that any number of the various types of information may be presented to the user in any combination, such as the program may begin with a religious message and then proceed to a news, financial, or sports report in any combination desired.

Again, while many of the embodiments have been discussed in connection with a dedicated portable device 104, which is provided only to receive incoming programs and messages, it is contemplated that portable device 104 may comprise a standard cellular telephone. The cell phone number need only be provided to program distributor/transmitter 102 along with the user's preferences relating to the message content and language. In this manner, program distributor/transmitter 102 may couple to the cellular telephone and transmit program 106 to be saved in voicemail. Many cellular telephones are equipped with an alarm feature such that the user need only retrieve the message from voicemail upon being awakened by the alarm feature. It may further be possible, depending upon the design of the cellular telephone, to have the message automatically play on speaker for the user at a specified time.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for transmission of a relatively short religious program to a plurality of receiving devices comprising:
a receiving device identifier to identify a connected receiving device;
a relatively short religious program to be transmitted to the receiving device;
a system transmitter for transmitting said relatively short religious program to the receiving device;
a storage located in the receiving device for storing said relatively short religious program;
a schedule set by the user for presentation of said relatively short religious program to the user;
said schedule comprising a repeating schedule to repeatedly play the relatively short religious program according to a start time and a pause time;
said receiving device presenting said relatively short religious program to the user according to said schedule.

2. The system according to claim 1 further comprising a program controller for controlling said system transmitter.

3. The system according to claim 2 wherein said system transmitter comprises a transmitter/receiver for sending and receiving signals.

4. The system according to claim 3 further comprising a user data/receiving device storage for storing data related to a user and a receiving device associated with the user.

5. The system according to claim 3 further comprising a program content storage for storing updated program content to be sent to the plurality of receiving devices.

6. The system according to claim 3 wherein said transmitter/receiver is coupled to a telephone network and said relatively short religious program is transmitted to the receiving device via the telephone network.

7. The system according to claim 1 wherein said relatively short religious program has a pre-selected length.

8. The system according to claim 7 wherein the pre-selected length is less than five minutes.

9. The system according to claim 7 wherein said relatively short religious program increases in volume as said program progresses.

10. The system according to claim 1 wherein said relatively short religious program is transmitted to the receiving device at a pre-selected time if the receiving device is coupled to the system.

11. The system according to claim 10 wherein said relatively short religious program is transmitted to the receiving device upon connection of the receiving device to the system when the pre-selected time is exceeded.

12. The system according to claim 1 wherein the relatively short religious program comprises a prayer or dedication.

13. The system according to claim 1 wherein the receiving device comprises a receiving device controller for controlling the presentation of said relatively short religious program to the user.

14. The system according to claim 13 further comprising a receiving device receiver/transmitter for transmitting an identification signal to the system and receiving a signal.

15. The system according to claim 14 further comprising a signal analyzer for analyzing the received signal to determine if the signal comprises the relatively short religious program.

16. The system according to claim 15 further comprising a program storage for storing said relatively short religious program.

17. The system according to claim 1 wherein said receiving device further comprising an audio transducer for presentation of said relatively short religious program to the user.

18. The system according to claim 1 wherein said receiving device further comprising an interface for input of user data and preferences to the receiving device.

19. The system according to claim 18 further comprising a user and preferences storage for storage of the user data and preferences.

20. The system according to claim 18 wherein said receiving device further comprising a display for visual display of data.

21. The system according to claim 20 wherein the visual data is selected from the group consisting of: time of day, date, alarm setting, on/off setting and combinations thereof.

22. A system for transmission of a program to a plurality of receiving devices comprising:
a receiving device identifier to identify a connected receiving device;
a program to be transmitted to the receiving device;
a system transmitter/receiver for transmitting said program to the receiving device;
a storage located in the receiving device for storing said program;
a schedule set by the user for presentation of said program to the user;
said receiving device presenting said program to the user according to said schedule.

23. The system according to claim 22 further comprising;
a program controller for controlling said system transmitter/receiver;
a user data/mobile device storage for storing data related to the user and the receiving device associated with the user.

24. The system according to claim 23 further comprising a program content storage for storing updated program content to be sent to the plurality of receiving devices.

25. The system according to claim 23 wherein said transmitter/receiver is coupled to a telephone network and said program is transmitted to the receiving device via the telephone network.

26. The system according to claim 22 wherein said program is transmitted to the receiving device at a pre-selected time if the receiving device is coupled to the system.

27. The system according to claim 26 wherein said program is transmitted to the receiving device upon connection of the receiving device to the system when the pre-selected time is exceeded.

28. The system according to claim 22 wherein said program comprises religious content.

29. The system according to claim 22 wherein the receiving device comprises:
a device controller for controlling the presentation of said program
a receiving device receiver/transmitter for transmitting an identification signal to the system and receiving a signal.

30. The system according to claim 29 further comprising a signal analyzer for analyzing the received signal to determine if the signal comprises said program.

31. A system for transmission of a program to a user comprising:
a program transmitter/receiver for receiving an identification signal from a connected portable device;
an identifier for identifying the connected portable device;
said program transmitter/receiver transmitting a program signal to the portable device;
said portable device including:
a device controller for controlling the presentation of said program;
a portable device transmitter/receiver for transmitting the identification signal to said program transmitter/receiver and for receiving a signal;
a signal analyzer coupled to said portable device transmitter/receiver for analyzing the received signal to determine if the received signal comprises the program;
a storage for storing the program upon determination that the received signal comprises the program;
a schedule for presentation of the program to the user;
said portable device presenting the program to the user according to said schedule.

32. The system according to claim 31 wherein said program transmitter/receiver is coupled to a telephone network and the program is transmitted to the portable device via the telephone network.

33. The system according to claim 31 wherein said portable device further comprises an interface for input of user data and preferences.

34. The system according to claim 33 further comprising a user and preferences storage for storage of the user data and preferences.

35. The system according to claim 31 wherein said portable device further comprises a display for visual display of data.

36. The system according to claim 35 wherein the visual data is selected from the group consisting of: time of day, date, alarm setting, on/off setting and combinations thereof.
